(19) United States
(12) Patent Application Publication
(10) Pub. No.: US 2006/0044290 A1
(43) Pub. Date: Mar. 2, 2006

(54) Electronic privacy filter

(76) Inventors: Roger A. Hurwitz, Portland, OR (US); Vittal Kini, Aloha, OR (US); Ralph Mesmer, Banks, OR (US); Lawrence Booth JR., Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/926,125

(22) Filed: Aug. 24, 2004

(51) Int. Cl. G09G 5/00

(52) U.S. Cl. 345/204

(57) ABSTRACT

In some embodiments, a device includes an electronic privacy filter. Other embodiments are disclosed and claimed.

The invention relates to electronic devices and more particularly to devices having displays, and methods related thereto.

### BACKGROUND AND RELATED ART

Privacy filters are well known in the art. Conventional privacy filters are generally passive films that may be placed over a display to restrict the viewing angle for the display.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the invention.

FIG. 1 is a schematic chart illustrating different modes of operation for an electronic privacy filter in accordance with some embodiments of the invention.

FIG. 2 is a perspective view of a laptop computer including an electronic privacy filter in accordance with some embodiments of the invention.

FIG. 3 is a schematic view of a handheld electronic device including an electronic privacy filter in accordance with some embodiments of the invention.

FIG. 4 is a perspective view of a personal video player including an electronic privacy filter in accordance with some embodiments of the invention.

FIG. 5 is a perspective view of a flat panel display including an electronic privacy filter in accordance with some embodiments of the invention.

FIG. 6 is a schematic view of a portable computing device including a display with an integrated electronic privacy filter in accordance with some embodiments of the invention.

FIG. 7 is an enlarged, schematic cross sectional view of the area 7 in FIG. 6.

FIG. 8 is a schematic view of another portable computing device including a display with an integrated electronic privacy filter in accordance with some embodiments of the invention.

FIG. 9 is an enlarged, schematic cross sectional view of the area 9 in FIG. 8.

FIG. 10 is a schematic view of another portable computing device including a display with an integrated electronic privacy filter in accordance with some embodiments of the invention.

FIG. 11 is an enlarged, schematic cross sectional view of the area 11 in FIG. 10.

FIG. 12 is a schematic view of an electronic privacy filter in accordance with some embodiments of the invention.

FIG. 13 is a schematic view of another electronic privacy filter in accordance with some embodiments of the invention.

FIG. 14 is a schematic view of another electronic privacy filter in accordance with some embodiments of the invention.

FIG. 15 is a partially perspective view of user terminal including an electronic privacy filter in accordance with some embodiments of the invention.

### DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

Laptop users are familiar with privacy filters that when placed over their displays inhibit individuals sitting nearby from seeing the contents of the display. While effective, traditional privacy filters are cumbersome to install and must be physically removed before the laptop owner can share the contents of his screen with others, for example, as the user may do in a small meeting where no overhead projection system was available.

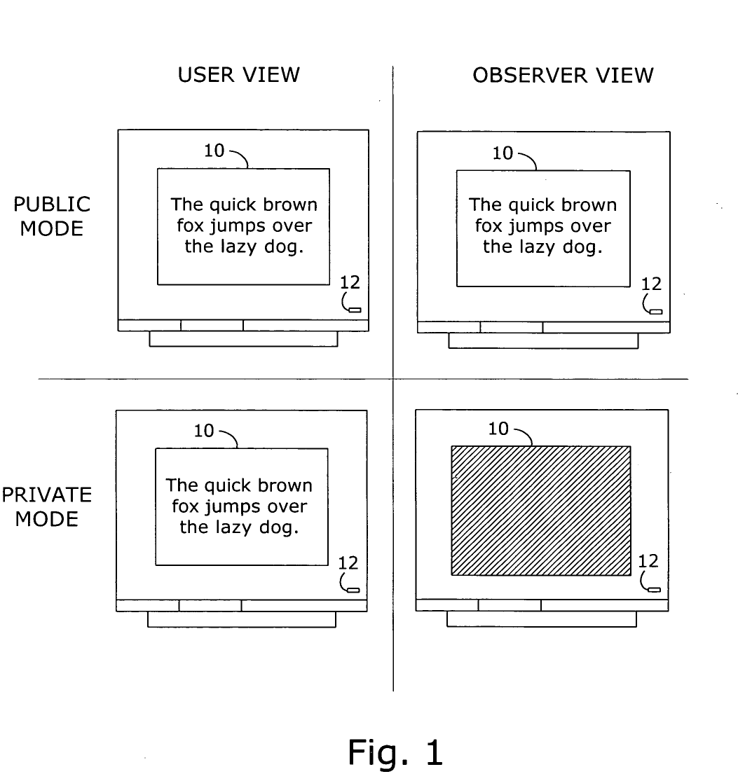

According to some embodiments of the present invention, an electronic privacy filter enables a user to electronically change the visibility of a display such that the electronic privacy filter inhibits others from seeing the contents of the display when in privacy mode and allows others to see the contents of the display when in public mode. With reference to FIG. 1, the diagram illustrates an example of two modes of operation enabled by some embodiments of the invention from the perspective of the user and the perspective of a nearby observer. In an electronically established public mode, a display 10 is readily visible in both a user view and an observer view. In an electronically established private mode, the display 10 is readily visible in the user view, but is obscured in the observer view. Advantageously, switching between the two modes is electronically selectable by the user without having to install or remove a passive privacy filter. For example, the display 10 may include a button 12 which the user may press to activate or de-activate the private mode of operation. Alternatively, the display 10 may be interfaced with a processor-based system having software thereon which the user may utilize to activate or de-activate the private mode.

Because of the cumbersome nature of existing approaches, passive privacy screens are often not used thereby putting sensitive information at risk when processor-based devices are used in public spaces. Advantageously, an electronic privacy filter, according to some embodiments of the invention, may make the privacy capability a more convenient part of the processor-based device and may result in the more frequent use of the privacy mode, thereby providing better potential to protect sensitive information.

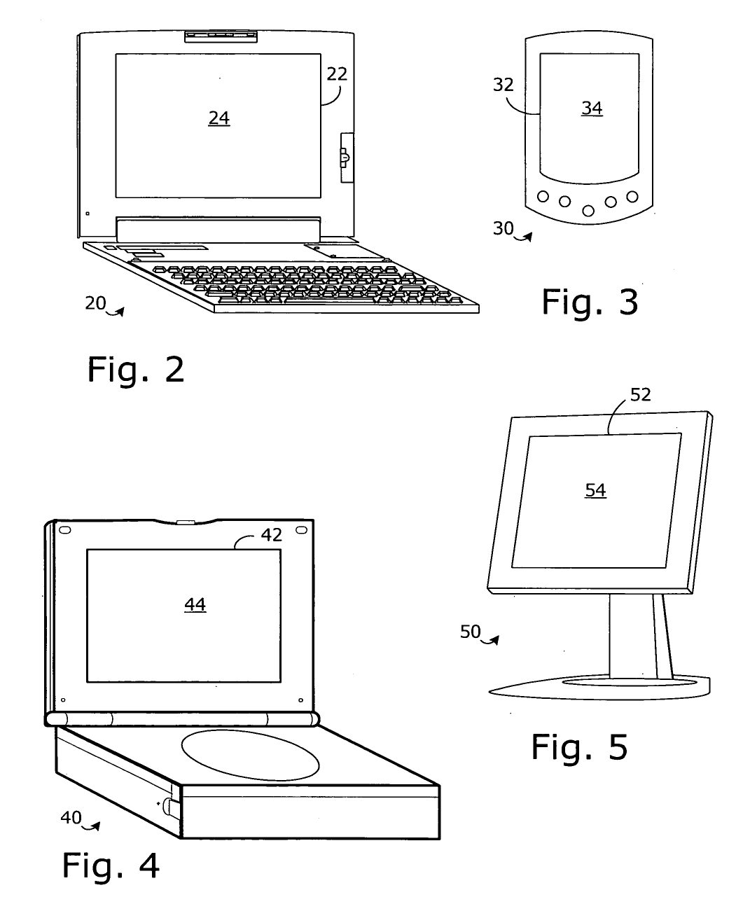

With reference to FIG. 2, a processor based device 20 includes a laptop computer having a flat panel display 22. The flat panel display 22 includes an electronic privacy filter 24 having at least two modes of operation, including a relatively more private mode and a relatively more public mode. For example, the electronic privacy filter 24 may alter the effective viewing angle of the display 22. In the relatively more public mode, the electronic privacy filter 24 may provide a relatively wide viewing angle. In the relatively more private mode, the electronic privacy filter 24 may provide a relatively narrow viewing angle. Thus, in the private mode the display 22 may be readily visible primarily to a user situated directly in front of the display while being obscured or having inhibited visibility to an observer outside of the relatively narrow viewing angle. However, if the user wanted to share the contents of the display, the user may set the electronic privacy filter to public mode, thereby providing the display with a wider viewing angle that may be readily visible to both the user and the observer.

Advantageously, switching between the two modes may be accomplished electronically by an input device on or connected to the laptop computer (e.g. a button press or a mouse click). In some embodiments of the invention, the electronic privacy filter 24 may provide viewing angles which can be electronically adjusted either discretely or continuously through a range of viewing angles. Accordingly, the user may select the degree of privacy desired through more than just two modes. For example, a dial or scroll wheel may be provided on the laptop computer 20 to accept input from the user to selectively increase or decrease the viewing angle of the display.

With reference to FIG. 3, a processor-based device 30 includes a hand-held device having a flat panel display 32. The flat panel display 32 includes an electronic privacy filter 34 having at least two modes of operation, including a relatively more private mode and a relatively more public mode. For example, the hand-held device may be a personal digital assistant (PDA), a digital music player, a cellular phone, a digital camera, or other portable processor-based device.

With reference to FIG. 4, a processor-based device 40 includes a personal video player having a flat panel display 42. The flat panel display 42 includes an electronic privacy filter 44 having at least two modes of operation, including a relatively more private mode and a relatively more public mode. For example, the personal video player may be a digital video disc (DVD) player, a digital camcorder, or other portable processor-based device. Advantageously, the player 40 with the electronic privacy filter 44 allows relatively more convenient private viewing of movies in public settings, such as at an airport or on an airplane.

With reference to FIG. 5, a stand-alone display device 50 includes a flat panel display 52. The flat panel display 52 includes an electronic privacy filter 54 having at least two modes of operation, including a relatively more private mode and a relatively more public mode. For example, the stand-alone device may be a computer monitor, an electronic picture frame, a flat panel television (including a high definition television), or other stand-alone display device.

In each of the foregoing examples, the electronic privacy filter may be integrated with the display, or may be added to the device as a retrofit electronic privacy filter. In general terms, the electronic privacy filter is constructed as follows. Where the native display provides a relatively wide viewing angle, the electronic privacy filter is configured to selectively narrow the viewing angle. Where the native display provides a relatively narrow viewing angle, the electronic privacy filter is configured to selectively widen the viewing angle. For example, various liquid crystal materials may be utilized to either increase or decrease the viewing angle. For example, twisted nematics (TN) or super twisted nematics (STN) liquid crystal material may provide a relatively narrow viewing angle, with the degree of twist being voltage controlled. Polymer dispersed liquid crystal (PDLC) material can be electronically switched between a relatively transparent state and a light scattering state. In the light scattering state of the PDLC, the viewing angle of the display may be increased. Various combinations of layers of liquid crystal materials and/or other optical materials with electrically modifiable properties may be utilized to construct an electronic privacy filter, in accordance with the various embodiments of the invention.

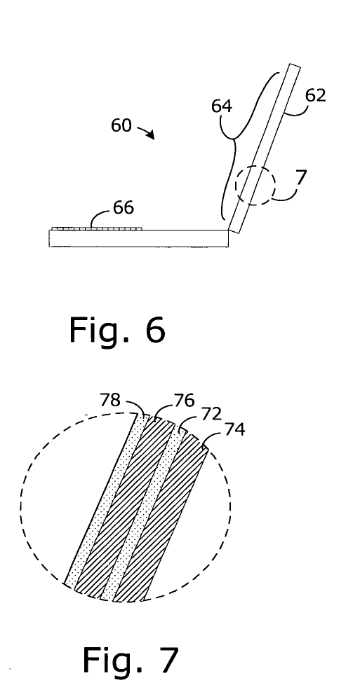

With reference to FIGS. 6-7, a processor-based device 60 includes a display 62 having an integrated electronic privacy filter 64. The device 60 may include an input device 66 (e.g. a keyboard). The user may control the mode of the electronic privacy filter 64 from the input device 66, e.g. with software running on the device 60. In some examples, an electronic view adjustment layer or layers may be added, e.g. as a film, to the display 62 as part of the manufacturing process for the display 62. For example, the view adjustment layers may change a polarization or otherwise adjust a perceived viewing angle for the display. Advantageously, adding the electronically controlled privacy layers may represent little or no additional cost as compared to conventional flat panel displays with multiple passive layers.

For example, the display 62 includes a multilayer LCD screen consisting of a base set of layers 72, 74, and 76 which provide a native viewing angle. The integrated privacy filter 64 may include an additional layer or set of layers 78 of electronically activated material, which can be electronically activated to adjust the perceived viewing angle for the display 62 to be different from the native viewing angle. For example, the LCD screen may include TN liquid crystal material 72 between two layers of glass 74 and 76, providing a relatively narrow viewing angle. The integrated privacy filter 64 may then include viewing angle enhancement material to selectively increase the perceived viewing angle of the display 62. For example, a PDLC material utilized in the set of layers 78 on the display 62 may provide a dispersive effect on the underlying image to selectively increase the perceived viewing angle for the display 62.

In another example, the LCD screen may include passive films or filters to provide a relatively wide viewing angle. For example, many conventional laptop display include multiple passive layers to increase the perceived viewing angle of the display. The integrated privacy filter 64 may then include viewing angle restrictive material to selectively decrease the perceived viewing angle of the display 62. For example, a TN liquid crystal material utilized in the set of layers 78 on the display 62 may provide a polarizing effect on the underlying image to selectively decrease the perceived viewing angle for the display 62.

The relatively more private and public modes may correspond to the respective viewing angles of the display image. In the private mode, the visibility of the display corresponds to the relatively narrow viewing angle of the underlying base set of layers. In the public mode, the visibility of the display will correspond to a relatively wider viewing angle provided the view angle enhancement material. Because switching between modes is electronically controlled, the user can switch modes without applying external devices to achieve privacy.

Power for the view angle enhancement layer(s) may be drawn from the processor-based device 60. For example, DC power may be provided from the battery of a laptop computer. Alternatively, when the laptop is plugged in for charging, power may be provided from the AC adapter or from the power conversion circuit within the laptop. A set of appropriate electrical contacts or electrodes are provided for the layer(s) as may be required by the particular material utilized for the view angle enhancement. Indium titanium oxide (ITO) is a transparent conductive material that may be suitable for either common electrodes or electrode arrays (e.g. individual electrodes corresponding to pixel locations).

Advantageously, in some embodiments, little or no power is drawn by the electronic privacy filter 64 in private mode. Accordingly, private mode may provide a power savings in many situations where private mode may be preferred, such as when using a laptop computer on battery power in a public place, such as an airport or airplane. Conversely, in some embodiments, public mode may be preferred in situations where AC power is available, such as when using the processor-based device in a meeting at a conference room.

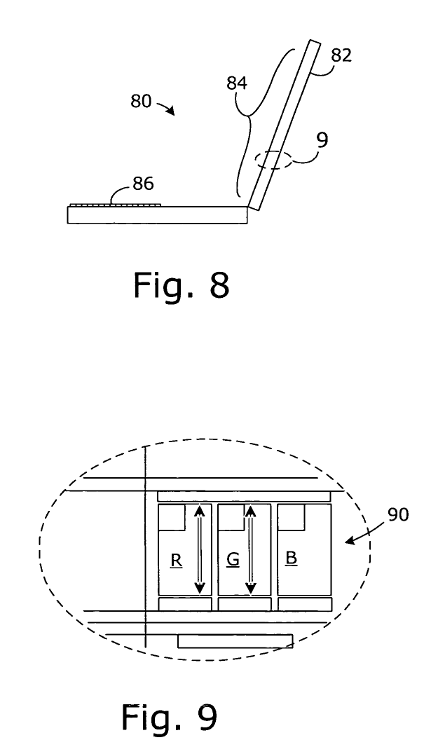

With reference to FIGS. 8-9, a processor-based device 80 includes a display 82 having an integrated electronic privacy filter 84. The device 80 may include an input device 86 (e.g. a keyboard). The user may control the mode of the electronic privacy filter 84 from the input device 86, e.g. with software running on the device 80. In some examples, an electronic view adjustment layer or layers may be added to the display 82 as part of the manufacturing process for the display 82. Advantageously, adding the electronically controlled privacy layers may represent little or no additional cost as compared to conventional flat panel displays with multiple passive layers.

For example, each pixel 90 may include separate red R, green G, and blue B regions, shown with representative row and columns address lines. Each pixel/line/dot/block may include a separate, selective alignment of the LC material in the affected area (preferably dots which are not black). By constructing the pixel electrode such that the LC aligns along a preferential direction (e.g. in the direction of the illustrated arrows), the viewing angle may be selectively reduced in one direction. The effect would be a relatively wide viewing angle in one direction (e.g. vertical) but a selectively reduced viewing angle in the other direction (e.g. horizontal).

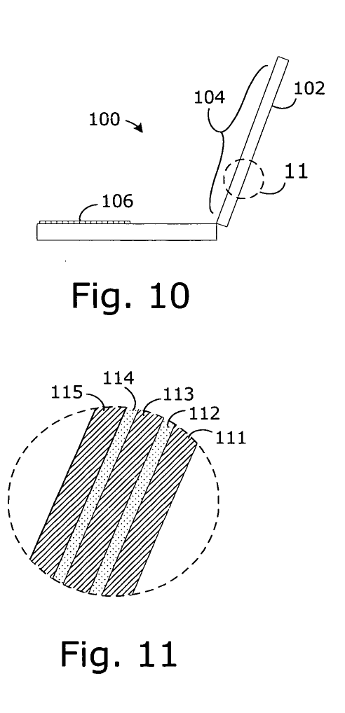

With reference to FIGS. 10-11, a processor-based device 100 includes a display 102 having an integrated electronic privacy filter 104. The device 100 may include an input device 106 (e.g. a keyboard). The user may control the mode of the electronic privacy filter 104 from the input device 106, e.g. with software running on the device 100.

For example, the display 102 includes a multilayer LCD screen consisting of a base set of layers which provide a relatively narrow viewing angle (e.g. TN liquid crystal material 112 between two layers of glass 111 and 113). The integrated privacy filter 104 includes an additional set of layers including a layer 114 of PDLC between a layer of glass 115 and the layer of glass 113. Advantageously, adding the electronically controlled privacy layers may represent little or no additional cost as compared to conventional flat panel displays with multiple passive layers.

In some examples, the PDLC layer 114 may provide two states including a transparent state and a scattering state. In the transparent state, the light from the LCD pixels may pass through the PDLC material relatively unchanged, providing the relatively more private mode. In the scattering state, the light from the pixels may be scattered, providing the relatively more public mode.

The relatively more private and public modes may correspond to the respective viewing angles of the display image. In the transparent state, the visibility of the display corresponds to the relatively narrow viewing angle of the underlying base set of layers (e.g. the TN material). In the scattering state, the visibility of the display will correspond to a relatively wider viewing angle provided the view angle enhancement of the PDLC material (e.g. the light scattering effect of the PDLC). Because the PDLC state is voltage controlled, switching between public and privates modes can be performed by the user without applying external devices to achieve privacy.

Power for the PDLC layer(s) may be drawn from the processor-based device 100. For example, DC power may be provided from the battery of a laptop computer. Alternatively, when the laptop is plugged in for charging, power may be provided from the AC adapter or from the power conversion circuit within the laptop. For example, for the PDLC layer 114, conductive indium titanium oxide (ITO) layers positioned on both sides of the PDLC material (e.g. on glass layers 113 and 115) may provide suitable electrodes for applying a voltage across the PDLC material.

Advantageously, in some embodiments, little or no power is drawn by the electronic privacy filter 104 in private mode. Accordingly, private mode may provide a power savings in many situations where private mode may be preferred, such as when using a laptop computer on battery power in a public place, such as an airport or airplane. Conversely, in some embodiments, public mode may be preferred in situations where AC power is available, such as when using the processor-based device in a meeting at a conference room.

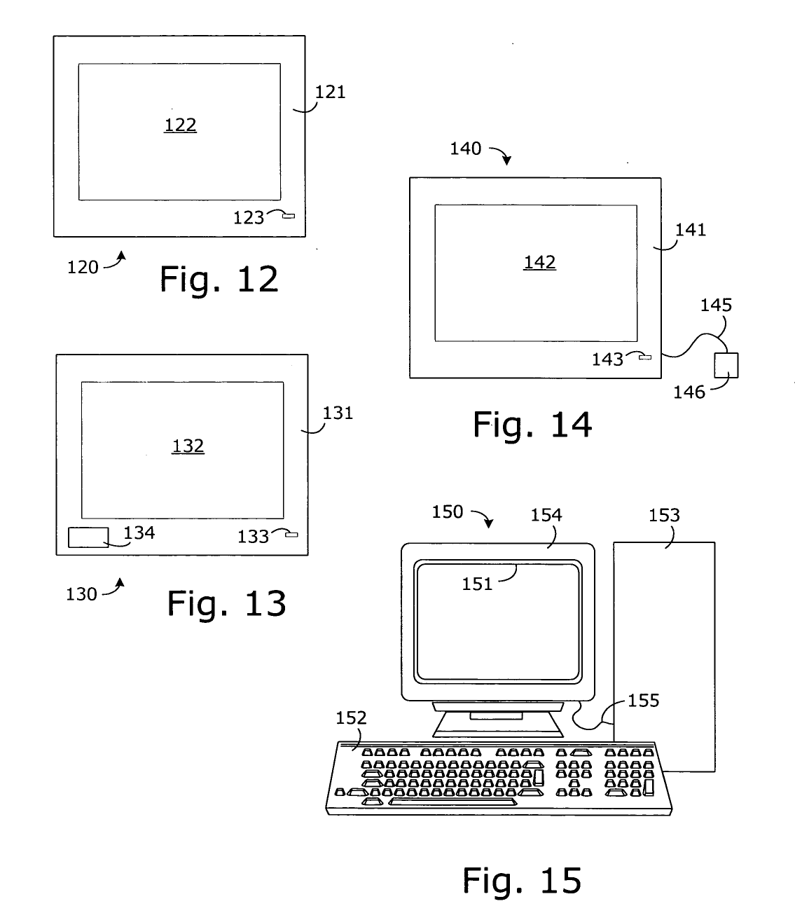

With reference to FIG. 12, a retrofit electronic privacy filter 120 includes a frame 121 positioned around a filter 122. The frame 121 may have any suitable size and shape, preferably corresponding to various standard shapes for laptop displays or other computer monitors. The filter 122 may be electronically switched between a private mode and a public mode. For example, the filter 122 may include a layer of optical material between two layers of glass, with substantially transparent electrodes on the respective inside faces of the two glass layers. For example, the optical material and driving signal may be selected to either increase or decrease the viewing angle of a display positioned to be viewed through the filter 122. The frame 121 may be configured to be attached to a display. For example, the frame 121 may be attached to the display with adhesive, hook and loop fasteners (e.g. Velcro®), clips, or by other conventional techniques. The electronic privacy filter 120 may include an optional input device 123 which may be operated by the user to switch between private and public mode(s).

With reference to FIG. 13, another retrofit electronic privacy filter 130 includes a frame 131 positioned around a filter 132. The frame 131 may have any suitable size and shape, preferably corresponding to various standard shapes for laptop displays or other computer monitors. The filter 132 may be electronically switched between a private mode and a public mode, e.g. by using optional input device 133. The electronic privacy filter 130 further includes a battery compartment 134 for receiving batteries to power the filter 130. For example, substantially flat, disc shaped batteries may be preferred.

With reference to FIG. 14, another retrofit electronic privacy filter 140 includes a frame 141 positioned around a filter 142. The frame 141 may have any suitable size and shape, preferably corresponding to various standard shapes for laptop displays or other computer monitors. The filter 142 may be electronically switched between a private mode and a public mode, e.g. by using optional input device 143. The electronic privacy filter 140 further includes a cable 145 and connector 146 for connecting the electronic privacy filter to a processor-based device. The electronic privacy filter 140 may receive power and control signals through the cable 145. For example, the connector 146 may include a universal serial bus (USB) connector. Advantageously, the USB specification provides for powered ports, which may provide sufficient power for the electronic privacy filter 140. In some embodiments, a thin, flat cable may be preferred for cable 145, so that a display retrofit with the filter 140 may be closed without substantial interference from the cable 145.

With reference to FIG. 15, a user terminal 150 includes a display 151 and a keyboard 152 connected to a processor-based device 153, such as a personal computer. The display 151 may be either a flat panel display or a convention cathode ray tube (CRT) type computer monitor. In accordance with some embodiments of the invention, the display 151 is retrofitted with an electronic privacy filter 154 connected to the processor-based device by a cable 155, so that the privacy of the user terminal 150 is improved. For example, the retrofitted electronic privacy filter 154 may be useful in public settings where user terminals are provided, such as public libraries or the search facilities of the Patent Office.

The foregoing and other aspects of the invention are achieved individually and in combination. The invention should not be construed as requiring two or more of such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

What is claimed is:

1. An apparatus, comprising:
a display; and
an electronic privacy filter positioned on the display, wherein the electronic privacy filter may be electronically switched between at least two modes including a private mode and a public mode.

2. The apparatus of claim 1, wherein the electronic privacy filter is configured to reduce the effective viewing angle for the display in the private mode as compared to the public mode.

3. The apparatus of claim 1, further comprising:
an input device operable to switch between the at least two modes for the electronic privacy filter.

4. The apparatus of claim 1, further comprising:
an input device operable to selectively adjust an effective viewing angle of the display through a range of viewing angles provided by the electronic privacy filter.

5. The apparatus of claim 1, wherein the display comprises an optical material having an effective viewing angle and wherein the electronic privacy filter comprises an optical material with electrically modifiable characteristics suitable to modify the effective viewing angle of the display upon application of an electrical signal to the electronic privacy filter.

6. The apparatus of claim 5, wherein the display comprises one of twisted nematic (TN) or super twisted nematic (STN) liquid crystal material and wherein the electronic privacy filter comprises polymer dispersed liquid crystal (PDLC) material.

7. The apparatus of claim 6, wherein the electronic privacy filter is integrated with the display.

8. The apparatus of claim 7, wherein the display with the integrated electronic privacy filter comprises three layers of glass with the TN or STN liquid crystal material between the first and second layers of glass and the PDLC material between the second and third layers of glass.

9. A method, comprising:
providing an electronic privacy filter on a display; and
electronically switching the electronic privacy filter between at least two modes, including a private mode and a public mode.

10. The method of claim 9, wherein electronically switching the electronic privacy filter between at least two modes comprised:
changing the effective viewing angle for the display.

11. The method of claim 9, further comprising:
operating an input device to switch between the at least two modes for the electronic privacy filter.

12. The method of claim 9, further comprising:
operating an input device to selectively adjust an effective viewing angle of the display through a range of viewing angles provided by the electronic privacy filter.

13. The method of claim 9, further comprising:
providing the display with an optical material having an effective viewing angle;
providing the electronic privacy filter with an optical material having electrically modifiable characteristics suitable to modify the effective viewing angle of the display upon application of an electrical signal to the electronic privacy filter.

14. The method of claim 13, wherein the display comprises one of twisted nematic (TN) or super twisted nematic (STN) liquid crystal material and wherein the electronic privacy filter comprises polymer dispersed liquid crystal (PDLC) material.

15. The method of claim 14, further comprising:
integrating the electronic privacy filter with the display.

16. The method of claim 15, wherein the integrating comprises:
providing three layers of glass;
positioning the TN or STN liquid crystal material between the first and second layers of glass; and
positioning the PDLC material between the second and third layers of glass.

17. A system, comprising:
a processor-based device;
a display operatively connected to the processor-based device; and
an electronic privacy filter positioned on the display, wherein the electronic privacy filter may be electronically switched between at least two modes including a private mode and a public mode.

18. The system of claim 17, wherein the electronic privacy filter is configured to reduce the effective viewing angle for the display in the private mode as compared to the public mode.

19. The system of claim 17, further comprising:
an input device operable to switch between the at least two modes for the electronic privacy filter.

20. The system of claim 17, further comprising:
an input device operable to selectively adjust an effective viewing angle of the display through a range of viewing angles provided by the electronic privacy filter.

21. The system of claim 17, wherein the display comprises an optical material having an effective viewing angle and wherein the electronic privacy filter comprises an optical material with electrically modifiable characteristics suitable to modify the effective viewing angle of the display upon application of an electrical signal to the electronic privacy filter.

22. The system of claim 21, wherein the display comprises one of twisted nematic (TN) or super twisted nematic (STN) liquid crystal material and wherein the electronic privacy filter comprises polymer dispersed liquid crystal (PDLC) material.

23. The system of claim 22, wherein the electronic privacy filter is integrated with the display.

24. The system of claim 23, wherein the display with the integrated electronic privacy filter comprises three layers of glass with the TN or STN liquid crystal material between the first and second layers of glass and the PDLC material between the second and third layers of glass.

25. An apparatus, comprising:
an electronic privacy filter; and
a frame positioned around the electronic privacy filter, wherein the electronic privacy filter may be electronically switched between at least two modes including a private mode and a public mode.

26. The apparatus of claim 25, wherein the electronic privacy filter is configured to reduce the effective viewing angle through the filter in the private mode as compared to the public mode.

27. The apparatus of claim 25, further comprising:
an input device operable to switch between the at least two modes for the electronic privacy filter.

28. The apparatus of claim 25, further comprising:
an input device operable to selectively adjust an effective viewing angle of the display through a range of viewing angles provided by the electronic privacy filter.

29. The apparatus of claim 25, wherein the electronic privacy filter comprises an optical material with electrically modifiable characteristics suitable to modify the effective viewing angle of the display upon application of an electrical signal to the electronic privacy filter.

30. The apparatus of claim 29, wherein the electronic privacy filter comprises polymer dispersed liquid crystal (PDLC) material.

31. The apparatus of claim 30, wherein the electronic privacy filter comprises two layers of glass with the PDLC material positioned between the two layers of glass.
